(19) United States
(12) Patent Application Publication
(10) Pub. No.: US 2022/0127174 A1
(43) Pub. Date: Apr. 28, 2022

(54) Wastewater Treatment Membrane Electro Membrane

(71) Applicant: Justin Bonn, Stoney Creek (CA)

(72) Inventors: Justin Andrew Bonn, Caistor Centre (CA); Richard Hamilton Nie, St. Catharines (CA); Kevin Grant Hall, New Market (CA)

(21) Appl. No.: 17/081,633

(22) Filed: Oct. 27, 2020

(51) Int. Cl. C02F 9/00; C02F 1/463; C02F 1/467; C02F 1/52; C02F 1/78; C02F 1/72; C02F 3/12

(52) U.S. Cl. CPC C02F 9/00; C02F 1/463; C02F 1/4672; C02F 2101/16; C02F 1/78; C02F 1/727; C02F 3/1268; C02F 1/5281

(57) ABSTRACT

In an apparatus for treating wastewater, water is screened, biologically treated and coagulated with the addition of chemicals before it is drawn through a membrane filter to produce permeate that is then passed through an electro-chemical cell to coagulate and/or oxidize residual contaminants such as phosphorous, nitrogen, or ammonia, and is then passed through a secondary membrane filter to capture and remove any remaining contaminants.

### CROSS REFERENCE TO RELATED APPLICATIONS

Not Applicable

### STATEMENT REGARDING FEDERALLY SPONSORED RESEARCH OR DEVELOPMENT

Not Applicable

### NAMES OF PARTIES TO A JOINT RESEARCH AGREEMENT

Not Applicable

### SEQUENCE LISTING

Not Applicable

### STATEMENT REGARDING PRIOR DISCLOSURES

Not Applicable

### BACKGROUND OF INVENTION

### Field of Invention

This invention relates to water and wastewater treatment and more particularly but not limited to a reduction of residual contaminants found in the permeate produced by Membrane Bio-Reactor (MBR) treatment systems

### Description of Related Art

A variety of methods can be employed to remove contaminants from wastewater with equipment selections targeted to meet the discharge objectives established by governing bodies.

MBR treatment systems produce a high quality effluent suitable for discharge to receiver streams where the loadings of contaminants are of paramount concern. In addition to providing a high-quality effluent, MBR treatment is compact as they function well with a high concentration of activated sludge reducing the reactor size and eliminating the need for secondary clarifiers and sand filters, this makes MBR treatment advantageous where there are space constraints and a small footprint is required. MBR configurations consist of internal/submerged when immersed in a biological reactor and external/side stream when located outside of a biological reactor.

Electro-chemical cells in wastewater treatment can be used for the removals of numerous contaminants, including but not limited to, total suspended solids (TSS), heavy metals, emulsified oils (FOG), bacteria, viruses, biological oxygen demand (BOD), chemical oxygen demand (COD), ammonia, nitrites, nitrates, phosphorus, polyfluoroalkyl substances (PFAS), pharmaceuticals, and other contaminants of interest such as micro toxins from algae. Electro-chemical cell configurations consist of a watertight housing, internal conductive metal plates commonly known as anodes and cathodes, and a DC power supply to induce an adjustable current.

Tertiary membrane filtration is used in applications that require lower concentrations of effluent TSS or associated contaminants than other tertiary filtration methods such as sand or cloth filters.

### SUMMARY OF INVENTION

When combining the treatment capabilities of a MBR, electro-chemical cell and tertiary membrane filter, water quality can be significantly improved, producing a permeate/effluent containing ultra low levels of contaminants at a far more economical rate. The use of a MBR for pre-treatment allows the electro-chemical cell to focus on a specific range of contaminants which results in treatment efficiencies.

As human and industrial activities increase around the world, the consumption of water results in the creation of wastewater with increasing contaminant levels. In the case of new developments, users must obtain the necessary permits and approvals to discharge contaminants to the surrounding environment. Treated effluent is generally discharged through a subsurface tile bed which impacts aquifers used for drinking water, or to a body of surface water which impacts drinking water, aquatic life and vegetation growth. Environmental authorities are responsible to ensure that aquifers and surface water ways do not become overloaded with contaminants. Developments are often restricted to ensure that contaminants do not pollute these water sources rendering them unsuitable for consumption or unsafe to aquatic life. This invention provides an economical solution to further reduce contaminant loadings into the environment by minimizing the impacts of growth in human and industrial activities.

### DRAWING DESCRIPTION

FIG. 1 shows a general arrangement of the treatment process claimed.

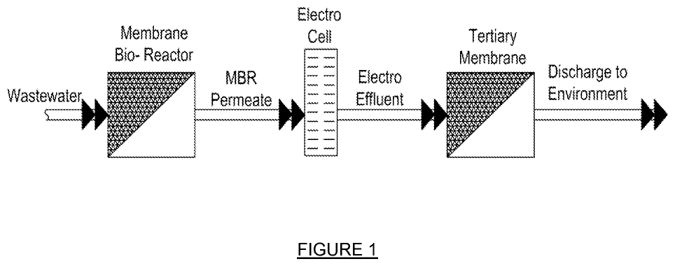

### DETAILED DESCRIPTION OF THE INVENTION

A reduction of residual contaminants found in permeate produced by a Membrane Bio-Reactor (MBR) can be achieved by further treatment of the MBR permeate in an electro-chemical cell where coagulation and/or oxidization may occur depending on the targeted contaminants. Optionally, concentrated oxygen (50% and higher) or ozone is added to the MBR permeate to enhance residual contaminant removal by the electro-chemical cell. Effluent from the electro-chemical cell is then passed through a secondary membrane functioning as a tertiary filter to capture and remove any remaining residual contaminants.

### SEQUENCE LISTING

Not Applicable

1. A process for removing contaminants from wastewater comprising of: (a) flowing wastewater into a Membrane Bio-Reactor (MBR) with permeate extracted, (b) MBR permeate flowing into an electro-chemical cell where coagulation and/or oxidation may occur producing an effluent, (c) Electro-chemical cell effluent flowing into a secondary membrane for tertiary treatment with a final permeate/effluent discharged to the environment and suitable for an application of reuse.

2. The system of claim 1 wherein the MBR coagulates contaminants using a chemical additive and provides pre-treatment for the electro-chemical cell effectively increasing the efficiency of the electro-chemical treatment process by reducing the capital and operational costs to treat specified contaminants.

3. The system of claim 1 wherein concentrated oxygen (50% and higher) or ozone may be added to the MBR permeate to enhance residual contaminant removal effectively increasing the efficiency of the electro-chemical treatment process by reducing the capital and operational costs to treat specified contaminants.

4. The system of claim 1 wherein the electro-chemical cell is comprised of an anode-cathode pair and is in contact with permeate generated by the MBR.

5. The system of claim 1 wherein the secondary membrane is in contact with effluent generated by the electro-chemical cell and produces a permeate/effluent with contaminant concentrations between 0.05 mg/L and 0.00 mg/L.

6. The system of claim 1 wherein contaminants may include but are not limited to ammonia, nitrogen, phosphorous, total suspended solids (TSS), heavy metals, emulsified oils (FOG), bacteria, viruses, biological oxygen demand (BOD), chemical oxygen demand (COD), polyfluoroalkyl substances (PFAS) and pharmaceuticals.

7. The system of claim 1 wherein the final permeate/effluent discharged is suitable for use as a potable water source.
